(19) United States
(12) Patent Application Publication
(10) Pub. No.: US 2011/0300909 A1
(43) Pub. Date: Dec. 8, 2011

(54) Portable radio communication device

(75) Inventor: Hisanobu Namima, Kanagawa-ken (JP)

(73) Assignee: Kabushiki Kaisha Kenwood, Tokyo (JP)

(21) Appl. No.: 13/067,036

(22) Filed: May 4, 2011

(30) Foreign Application Priority Data
Jun. 8, 2010 (JP) 2010-131033

(51) Int. Cl. H04B 1/38

(52) U.S. Cl. 455/566

(57) ABSTRACT

A portable radio communication device includes a radio section using a frequency for at least one of signal reception and signal transmission. The frequency used by the radio section is set to a frequency assigned to a memory channel. A mute circuit mutes an audio output circuit when a mute-cancel or monitor switch is not operated, and unmutes the audio output circuit when the switch is operated. A display is controlled to indicate a name assigned to the memory channel when the switch is not operated, and to indicate the frequency assigned to the memory channel when the switch is operated.

### BACKGROUND OF THE INVENTION

1. Field of the Invention

This invention relates to a portable or handheld radio communication device which can change a frequency registered in or assigned to a memory channel while monitoring the frequency.

2. Description of the Related Art

Generally, a portable or handheld radio communication device is designed for transmitting and receiving signals of frequencies in a predetermined range. In most cases, the communication device does not use all frequencies in the predetermined range but uses specified frequencies selected from the predetermined range only. The specified frequencies are registered in or assigned to respective memory channels through the use of a memory in the communication device. For example, one of the specified frequencies assigned to the respective memory channels is retrieved from the memory before being used by the communication device.

In the case where only numerals representative of each specified frequency assigned to a memory channel are indicated on a display of a communication device, it is not easy for a user to perceive or remember the purpose of the specified frequency.

Accordingly, in a known advanced communication device, a set of data representative of numerals of each specified frequency and data representative of letters or characters suggesting the purpose of the specified frequency is stored in a memory of the communication device as data of a memory channel. Such letters are referred to as a memory name. When a specified frequency assigned to a memory channel is retrieved, a set of data representative of numerals of the specified frequency and data representative of a memory name suggesting the purpose of the specified frequency is read out from the memory. Then, the data representative of the memory name is fed to a display of the communication device so that the memory name is indicated on the display. Thus, by referring to the memory name, it is easy for a user to perceive or remember the purpose of the specified frequency.

In amateur radio, it is a custom to monitor a frequency to be used for signal transmission to check whether or not the frequency is used by another. Only when the frequency is not used, signal transmission is carried out.

An FM communication device tends to generate big noise sound in the absence of a received signal. A typical FM communication device is provided with a squelch circuit which mutes the audio output of the device to prevent the generation of big noise sound in the absence of a received signal. The squelch circuit unmutes the audio output in the presence of a received signal.

An ordinary squelch circuit detects noise components of a demodulation-result signal which are outside a voice frequency band. The squelch circuit rectifies the detected noise components to get a noise indicator signal, and compares the level of the noise indicator signal with a threshold value. When the level of the noise indicator signal exceeds the threshold value, the squelch circuit concludes a received signal to be absent and mutes the audio output of a related device. Otherwise, the squelch circuit concludes a received signal to be present and unmutes the audio output. In general, conditions where a received signal is absent and the audio output is muted are called “squelch is closed”. On the other hand, conditions where a received signal comes in so that the audio output is released from the muted state are called “squelch opens”. In most cases, the threshold value can be adjusted by a user.

A weak received signal causes the level of the noise indicator signal to exceed the threshold value, and does not open the squelch. A known communication device is provided with a monitor switch which can be actuated by a user on a one-touch basis. When the monitor switch is actuated, a squelch in the communication device is forced to move from a closed state to an open state so that the presence or absence of a weak received signal can be ascertained.

In general, a handheld radio communication device has a side provided with a PTT (push to talk) switch. For easy operation by one hand, the monitor switch is positioned near the PTT switch.

Japanese patent application publication number 6-276110 discloses a radio communication device including a digital squelch (DSQ) and a DSQ cancel switch which can be actuated by a user. The radio communication device in Japanese application 6-276110 receives a signal containing digital data and speech components following the digital data. In the radio communication device, the digital data in the received signal is recovered. The recovered digital data is collated with reference digital data. In the event that the recovered digital data differs in contents from the reference digital data, the digital squelch mutes the audio output of the communication device. When the recovered digital data matches the reference digital data, the digital squelch unmutes the audio output of the communication device. In the case where the DSQ cancel switch is actuated, the digital squelch is disabled. Thus, in this case, the audio output of the communication device is forcedly unmuted even when the recovered digital data differs in contents from the reference digital data. Therefore, the speech contents of the received signal are converted into corresponding sounds as the audio output of the communication device.

In a handheld radio communication device, the size of a display is so limited that when a specified frequency registered in a memory channel is retrieved, only one of the specified frequency and a related memory name is indicated on the display. Furthermore, the handheld device has a severely limited number of operation switches. Thus, to implement writing data into a memory of the device or editing data in the memory, a user is required to perform complicated operation through the use of the operation switches. In the case where a specified frequency registered in a memory channel needs to be changed during operation of the device, a user is required to perform more complicated operation.

In amateur radio, it is legally required that a frequency used for signal transmission should not be off allowed frequency bands. In the case where only a memory name is indicated on the display of a radio communication device as information of a currently-selected memory channel, a specified frequency registered in the memory channel and used for signal transmission is not indicated and is not directly confirmed. This causes an inconvenience to prevent the frequency used for signal transmission from being off the allowed frequency bands.

### SUMMARY OF THE INVENTION

It is an object of this invention to provide a portable or handheld radio communication device which enables a user to easily perceive or remember the purpose of each specified frequency registered in a memory channel, which enables the user to simultaneously get indicated numerals of a specified frequency to be used for signal transmission and check whether or not the to-be-used specified frequency is already in use by another, and which enables the user to change a specified frequency registered in a memory channel while monitoring the specified frequency.

A first aspect of this invention provides a portable or handheld radio communication device comprising a radio section including a transmitting section and a receiving section, the transmitting section being configured to subject a to-be-transmitted signal to modulation to get a modulation-result signal and transmit the modulation-result signal, the receiving section being configured to receive an incoming signal and subject the received incoming signal to demodulation to get a demodulation-result signal; a frequency operation section configured to vary at least one of a frequency used by the radio section for signal transmission and a frequency used by the radio section for signal reception when being operated; a mute section configured to mute the outputting of the demodulation-result signal; a mute cancel operation section configured to cancel the muting by the mute section when being operated; a memory configured to store data sets assigned to respective memory channels, wherein each of the data sets includes frequency data representing at least one of a frequency used for signal transmission and a frequency used for signal reception, and letter data representing letters; a display; and a display control section configured to access the memory and control the display to indicate letters represented by letter data in a data set assigned to selected one of the memory channels when the mute cancel operation section is not operated to cancel the muting, and configured to access the memory and control the display to indicate at least one of a frequency for signal transmission and a frequency for signal reception which are represented by frequency data in the data set assigned to the selected one of the memory channels when the mute cancel operation section is operated to cancel the muting.

A second aspect of this invention is based on the first aspect thereof, and provides a portable or handheld radio communication device further comprising a general operation section configured to implement various types of setting in the communication device, wherein the mute cancel operation section and the general operation section are designed so that when the mute cancel operation section is operated by user's one hand, the general operation section can be operated by user's other hand without interference with user's one hand.

A third aspect of this invention is based on the second aspect thereof, and provides a portable or handheld radio communication device further comprising a mute control section configured to decide whether a received signal is present or absent, and enable the mute section when it is decided that a received signal is absent.

A fourth aspect of this invention is based on the second aspect thereof, and provides a portable or handheld radio communication device further comprising a mute control section configured to decide whether a specified signal addressed to the communication device is present in or absent from a received signal, and enable the mute section when it is decided that a specified signal addressed to the communication device is absent from a received signal.

A fifth aspect of this invention is based on the third aspect thereof, and provides a portable or handheld radio communication device wherein a frequency used by the radio section is varied as the frequency operation section is operated in cases where the display indicates a frequency in response to operation of the mute cancel operation section.

A sixth aspect of this invention is based on the fifth aspect thereof, and provides a portable or handheld radio communication device wherein frequency data representing a varied frequency used by the radio section at a moment of the end of operation of the mute cancel operation section is written over the frequency data in the data set assigned to the selected one of the memory channels.

A seventh aspect of this invention is based on the fifth aspect thereof, and provides a portable or handheld radio communication device wherein frequency data representing a varied frequency used by the radio section at a moment of the end of operation of the mute cancel operation section is discarded.

An eighth aspect of this invention is based on the fifth aspect thereof, and provides a portable or handheld radio communication device wherein the memory channels are separated into a first group and a second group, wherein frequency data representing a varied frequency used by the radio section at a moment of the end of operation of the mute cancel operation section is written over the frequency data in the data set assigned to the selected one of the memory channels in cases where the selected one of the memory channels is in the first group, and wherein frequency data representing a varied frequency used by the radio section at a moment of the end of operation of the mute cancel operation section is discarded in cases where the selected one of the memory channels is in the second group.

A ninth aspect of this invention is based on the fifth aspect thereof, and provides a portable or handheld radio communication device further comprising reception frequency changing means configured to exchange a frequency used by the radio section for signal transmission and a frequency used by the radio section for signal reception to monitor the frequency for signal transmission when being operated, wherein the frequency for signal transmission and the frequency for signal reception are alternately indicated each time the reception frequency changing means is operated while the mute cancel operation section remains operated.

A tenth aspect of this invention is based on the ninth aspect thereof, and provides a portable or handheld radio communication device wherein a frequency used by the radio section for signal reception is varied as the frequency operation section is operated in cases where the display indicates a frequency for signal reception in response to operation of the mute cancel operation section.

An eleventh aspect of this invention is based on the ninth aspect thereof, and provides a portable or handheld radio communication device wherein a frequency used by the radio section for signal transmission is varied as the frequency operation section is operated in cases where the display indicates a frequency for signal transmission in response to operation of the mute cancel operation section and operation of the reception frequency changing means.

A twelfth aspect of this invention is based on the ninth aspect thereof, and provides a portable or handheld radio communication device wherein a frequency used by the radio section for signal transmission and a frequency used by the radio section for signal reception are simultaneously varied and a difference therebetween remains constant as the frequency operation section is operated in cases where the display indicates a frequency in response to operation of the mute cancel operation section.

A thirteenth aspect of this invention provides a portable or handheld radio communication device comprising a radio section using a frequency for at least one of signal reception and signal transmission; means for setting the frequency used by the radio section to a frequency assigned to a memory channel; an audio output circuit; a switch; a mute circuit muting the audio output circuit when the switch is not operated, and unmuting the audio output circuit when the switch is operated; means for indicating to a user a name assigned to the memory channel when the switch is not operated; and means for indicating to the user the frequency assigned to the memory channel when the switch is operated.

A fourteenth aspect of this invention is based on the thirteenth aspect thereof, and provides a portable or handheld radio communication device wherein indication of the frequency replaces indication of the name when the switch is operated.

A fifteenth aspect of this invention is based on the thirteenth aspect thereof, and provides a portable or handheld radio communication device wherein indication of the frequency is added to indication of the name when the switch is operated.

This invention has the following advantage. In the case where a frequency assigned to a memory channel is currently selected and used by the radio section, when the mute cancel operation section or the switch is operated, the frequency is indicated by the display and hence can be directly confirmed. Furthermore, the frequency is monitored through the radio section so that a check can be made as to whether a received signal is present in or absent from the frequency.

### BRIEF DESCRIPTION OF THE DRAWINGS

FIG. 1 is a perspective view of a portable or handheld radio communication device according to an embodiment of this invention.

FIG. 2 is a block diagram of an electric portion of the communication device in FIG. 1.

FIG. 3 is a diagram of data sets stored in a memory in FIG. 2.

FIG. 4 is a flowchart of a segment of a control program for a control section in FIG. 2.

FIG. 5 is a diagram of data sets stored in a memory in a portable or handheld radio communication device according to another embodiment of this invention.

### DETAILED DESCRIPTION OF THE INVENTION

### First Embodiment

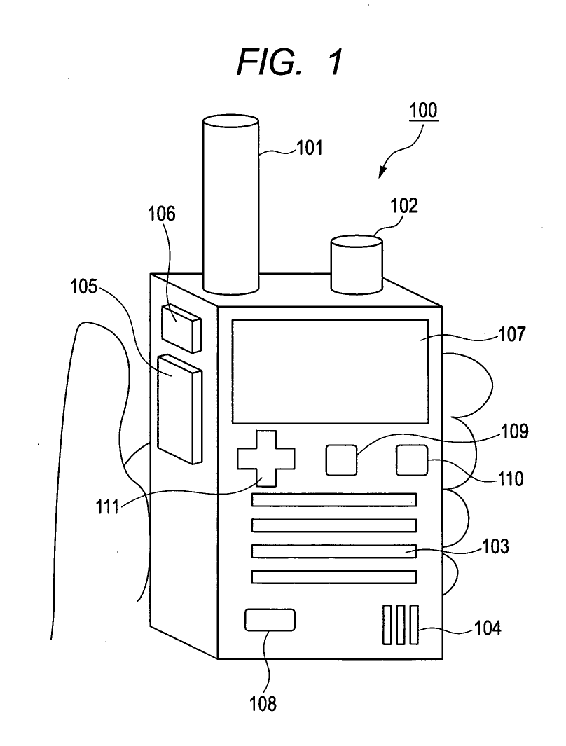

With reference to FIG. 1, a portable or handheld radio communication device 100 in a first embodiment of this invention includes a body having a top provided with an antenna 101 and a rotary encoder 102 for frequency control or frequency selection.

The body of the communication device 100 has a front provided with a loudspeaker grill 103, microphone apertures 104, a display 107, a power supply switch 108, a VFO/memory change switch 109, a memory write switch 110, and a directional pad or a cross key 111.

The communication device 100 can operate in either a VFO (variable frequency oscillator) mode or a memory channel mode. During the VFO mode of operation, a VFO in the communication device 100 is enabled so that the frequency to which the communication device 100 tunes is variable among frequencies spaced at predetermined intervals. In this case, varying the frequency to which the communication device 100 tunes can be implemented by actuating the rotary encoder 102. During the memory channel mode of operation, the frequency to which the communication device 100 tunes is one selected from specified frequencies registered in or assigned to respective memory channels. In this case, the frequency to which the communication device 100 tunes, that is, the selected frequency can be changed from one to another by actuating the rotary encoder 102.

The body of the communication device 100 has a side provided with a PTT (push to talk) switch 105 and a monitor switch 106. The monitor switch 106 is referred to as the mute cancel switch 106 also.

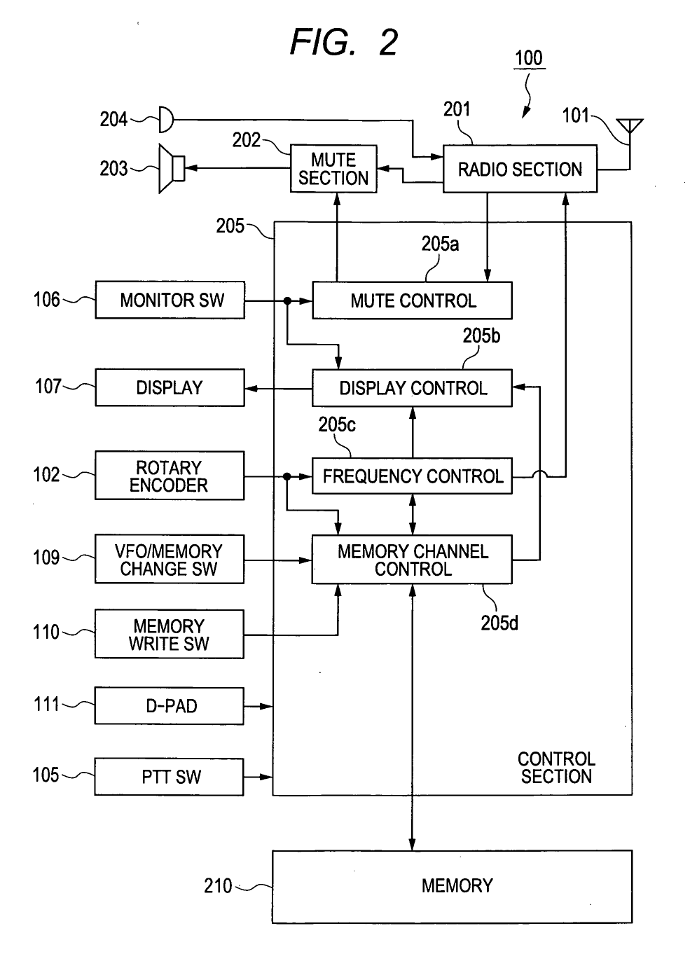

The body of the communication device 100 contains a loudspeaker 203 (see FIG. 2) at a place in the rear of the loudspeaker grill 103. The body of the communication device 100 contains a microphone 204 (see FIG. 2) at a place in the rear of the microphone apertures 104.

A power supply to the electric portion of the communication device 100 can be turned on and off by actuating the power supply switch 108.

Operation of the communication device 100 can be changed between the VFO mode and the memory channel mode by actuating the VFO/memory change switch 109.

During the VFO mode of operation, the frequency to which the communication device 100 tunes can be set as a specified frequency by actuating the memory write switch 110. In this case, data representative of the specified frequency is written into a memory within the communication device 100 and the specified frequency is registered in or assigned to a currently-selected memory channel in response to the actuation of the memory write switch 110.

The directional pad 111 has upper, lower, left-hand, and right-hand switches. The setting of various functions in the communication device 100 can be implemented by actuating the directional pad 111. A letter or a character can be selected by actuating the directional pad 111. For example, letter or character selections are implemented for inputting, into the communication device 100, data representative of letters or characters (a memory name) to be registered in or assigned to a memory channel.

Preferably, the display 107 includes an LCD (liquid crystal display). During the VFO mode of operation of the communication device 100, the display 107 indicates at least a frequency used for signal transmission or a frequency used for signal reception. During the memory channel mode of operation of the communication device 100, the display 107 indicates the channel number (the ID number) of a currently-selected memory channel and the specified frequency assigned to the currently-selected memory channel, or the memory name assigned to the currently-selected memory channel.

As shown in FIG. 1, the PTT switch 105 and the monitor switch (mute cancel switch) 106 are arranged so that they can be actuated by user's single hand.

The rotary encoder 102, the power supply switch 108, the VFO/memory change switch 109, the memory write switch 110, and the directional pad 111 are located so that they can be accessed by one hand of the user without interference while the PTT switch 105 or the monitor switch 106 remains actuated by the other hand of the user. Thus, the user can actuate one or more of the rotary encoder 102, the power supply switch 108, the VFO/memory change switch 109, the memory write switch 110, and the directional pad 111 while actuating the PTT switch 105 or the monitor switch 106.

When being pushed, the PTT switch 105 changes to its ON position where the communication device 100 assumes a transmission state. When being released, the PTT switch 105 returns to its OFF position where the communication device 100 assumes a reception state.

The communication device 100 includes a squelch (a squelch circuit) for selectively muting and unmuting an audio output of the device. For example, the squelch selectively blocks and unblocks the transmission of an audio signal to the loudspeaker 203 to implement the selective muting and unmuting. The monitor switch (mute cancel switch) 106 is electrically connected with the squelch. In the absence of a received signal strong enough to open the squelch, the audio output remains muted. When being pushed under such conditions, the monitor switch 106 changes to its ON position where the squelch is forced to open and the muting of the audio output is canceled so that speech represented by a weak received signal can be reproduced via the loudspeaker 203. When being released, the monitor switch 106 returns to its OFF position where the squelch is closed and the audio output is muted.

With reference to FIG. 2, the communication device 100 includes a radio section 201, a mute section 202, a control section 205, and a memory 210. The antenna 101 catches radio waves and converts them into received signals. The received signals are sent from the antenna 101 to the radio section 201. The radio section 201 feeds a to-be-transmitted signal to the antenna 101. The antenna 101 converts the to-be-transmitted signal into a radio wave and radiates the radio wave.

The radio section 201 includes a receiving section and a transmitting section. A received signal is sent from the antenna 101 to the receiving section in the radio section 201. The receiving section 201 subjects the received signal to demodulation to get a demodulation-result signal (an audio signal). Provided that the mute section 202 is in its OFF state, the demodulation-result signal is transmitted from the radio section 201 to the loudspeaker 203 through the mute section 202 before being converted into corresponding sounds by the loudspeaker 203.

The loudspeaker 203 and the audio-signal transmission line extending from the receiving section 201 to the loudspeaker 203 form at least a part of an audio output circuit of the communication device 100.

The microphone 204 converts user's speech into a corresponding audio signal. The audio signal is sent from the microphone 204 to the transmitting section in the radio section 201. The transmitting section subjects the audio signal to modulation to get a to-be-transmitted signal (an RF signal). Specifically, the transmitting section modulates a carrier in accordance with the audio signal to get the to-be-transmitted signal. The transmitting section feeds the to-be-transmitted signal to the antenna 101.

Preferably, the communication device 100 includes a power supply (not shown) such as a battery. The radio section 201, the control section 205, and other electric sections and parts are activated by electric power fed from the power supply.

The control section 205 is electrically connected with the rotary encoder 102, the PTT switch 105, the monitor switch 106, the display 107, the VFO/ memory change switch 109, the memory write switch 110, the directional pad 111, the radio section 201, the mute section 202, and the memory 210.

The control section 205 may include a computer having a combination of an input/output port, a processing unit, a ROM, a RAM, and a rewritable nonvolatile memory. In this case, the control section 205 operates in accordance with a control program stored in the ROM or the

RAM. The control program is designed to enable the control section 205 to implement operation steps mentioned hereafter.

Preferably, the control section 205 has a mute controller 205a, a display controller 205b, a frequency controller 205c, and a memory channel controller 205d. The controllers 205a-205d may be implemented by the above-mentioned control program for the control section 205. Preferably, the controllers 205a-205d are formed by a common computer or plural computers. The controllers 205a-205d operate in accordance with control programs stored in memories provided therein. The control programs are designed to enable the controllers 205a-205d to implement operation steps mentioned hereafter.

The mute section 202 selectively mutes and unmutes the audio output of the communication device 100 in response to a mute control signal from the mute controller 205a. Specifically, the mute section 202 changes between its ON state and its OFF state while being controlled by the mute controller 205a. When assuming the ON state, the mute section 202 blocks the transmission of the demodulation-result signal from the radio section 201 to the loudspeaker 203 and thereby mutes the audio output. When assuming the OFF state, the mute section 202 unblocks the transmission of the demodulation-result signal from the radio section 201 to the loudspeaker 203 and thereby unmutes the audio output.

The radio section 201 includes a conventional noise squelch circuit which implements noise detection and outputs a resultant noise detection signal to the mute controller 205a. The mute controller 205a compares the level of the noise detection signal with a predetermined threshold value. When the level of the noise detection signal is equal to or greater than the threshold value, the mute controller 205a sets the mute section 202 to its ON state so that the audio output is muted. When the level of the noise detection signal is smaller than the threshold value, the mute controller 205a sets the mute section 202 to its OFF state so that the audio output is unmuted.

The monitor switch 106 outputs a mute cancel command to the mute controller 205a when being pushed or actuated. The mute controller 205a forces the mute section 202 to fall into its OFF state in response to the mute cancel command. Thus, even in the case where the level of the noise detection signal is equal to or greater than the threshold value, the mute cancel command outputted from the monitor switch 106 causes the mute section 202 to forcedly assume its OFF state so that the muting of the audio output is canceled (that is, the audio output is unmuted).

The rotary encoder 102 includes a rotary shaft which can be actuated by the user. The rotary encoder 102 generates two-phase pulses as the rotary shaft is rotated. The rotary encoder 102 converts the generated pulses into a frequency-change command such as a frequency-up command or a frequency-down command depending on the phases of the generated pulses. The rotary encoder 102 outputs the frequency-change command to the frequency controller 205c.

The frequency controller 205c generates a frequency setting signal in response to the frequency-change command. The frequency controller 205c outputs the frequency setting signal to the radio section 201. The frequency to which the radio section 201 tunes, that is, the frequency used by the radio section for signal transmission or signal reception is set in accordance with the frequency setting signal.

Furthermore, the frequency controller 205c generates a frequency-indication change signal in response to the frequency-change command. The frequency controller 205c outputs the frequency-indication change signal to the display controller 205b.

The radio section 201 implements signal transmission or signal reception through the use of the frequency set in accordance with the frequency setting signal.

The display controller 205b generates an indication command in response to the frequency-indication change signal. The display controller 205b outputs the indication command to the display 107. The indication command controls the display 107 to indicate the frequency corresponding to the frequency-change command. Thus, the frequency indicated by the display 107 is changed in accordance with the frequency-change command.

During the memory channel mode of operation of the communication device 100, the rotary encoder 102 is used for changing the currently-accessed one among the memory channels. Specifically, the rotary encoder 102 generates two-phase pulses as its rotary shaft is rotated. The rotary encoder 102 converts the generated pulses into a memory-channel-change command such as a memory-channel-up command or a memory-channel-down command depending on the phases of the generated pulses. The memory-channel-up command is to change the currently-accessed memory channel from one to the next as viewed in the channel-ID-number increasing direction. The memory-channel-down command is to change the currently-accessed memory channel from one to the next as viewed in the channel-ID-number decreasing direction. The rotary encoder 102 outputs the memory-channel-change command to the memory channel controller 205d. The memory-channel-change command represents a memory channel to be selected or used.

The memory 210 stores data sets about the respective memory channels. The memory channel controller 205d reads out a data set about the to-be-used memory channel from the memory 210 in response to the memory-channel-change command. The memory channel controller 205d outputs frequency data in the read-out data set to the frequency controller 205c. The frequency data represents the frequency assigned to the to-be-used memory channel.

During the memory channel mode of operation of the communication device 100, the frequency controller 205c generates a frequency setting signal in response to the frequency data. The frequency controller 205c outputs the frequency setting signal to the radio section 201. The frequency to which the radio section 201 tunes, that is, the frequency used by the radio section 201 for signal transmission or signal reception is set in accordance with the frequency setting signal. Thus, the frequency to which the radio section 201 tunes is equalized to the frequency assigned to the to-be-used memory channel. Furthermore, the frequency controller 205c generates a frequency-indication change signal in response to the frequency data. The frequency controller 205c outputs the frequency-indication change signal to the display controller 205b. The display controller 205b generates an indication command in response to the frequency-indication change signal. The display controller 205b outputs the indication command to the display 107. The indication command controls the display 107 to indicate the frequency corresponding to the frequency data. In this way, the frequency indicated by the display 107 is changed in accordance with the frequency data. Thus, the frequency indicated by the display 107 is equalized to the frequency assigned to the to-be-used memory channel.

The communication device 100 can be set to indicate a memory name on the display 107 during the memory channel mode of operation. In the case where this setting has been made, the memory channel controller 205d outputs letter or character data in the read-out data set to the display controller 205b. The letter or character data represents letters or characters of the memory name assigned to the to-be-used memory channel. The display controller 205b generates an indication command in response to the letter or character data. The display controller 205b outputs the indication command to the display 107. The indication command controls the display 107 to indicate the letters or characters of the memory name assigned to the to-be-used memory channel. In this way, the memory name assigned to the to-be-used memory channel is indicated by the display 107.

In the case where the communication device 100 is set to indicate a memory name on the display 107 during the memory channel mode of operation, when the monitor switch 106 is pushed, a mute cancel command is outputted therefrom to the mute controller 205a and the frequency controller 205b. The mute controller 205a controls the mute section 202 to cancel the muting of the audio output in response to the mute cancel command. Furthermore, the display controller 205b responds to the mute cancel command, and thereby generates an indication command in response to the frequency data which comes from the memory channel controller 205d via the frequency controller 205c. The frequency data represents the frequency assigned to the currently-used memory channel. The display controller 205b outputs the indication command to the display 107. The indication command controls the display 107 to indicate the frequency assigned to the currently-used memory channel. On the display 107, indication of the frequency replaces indication of the memory name. Alternatively, indication of the frequency may be added to indication of the memory name. The frequency assigned to the currently-used memory channel continues to be indicated by the display 107 while the monitor switch 106 remains pushed. When the monitor switch 106 is released thereafter, the mute cancel command is removed. The mute controller 205a controls the mute section 202 to mute the audio output in response to the removal of the mute cancel command. Furthermore, the display controller 205b responds to the removal of the mute cancel command, and thereby controls the display 107 to indicate the memory name again. In this way, upon the release of the monitor switch 106, the memory name is indicated by the display 107 again.

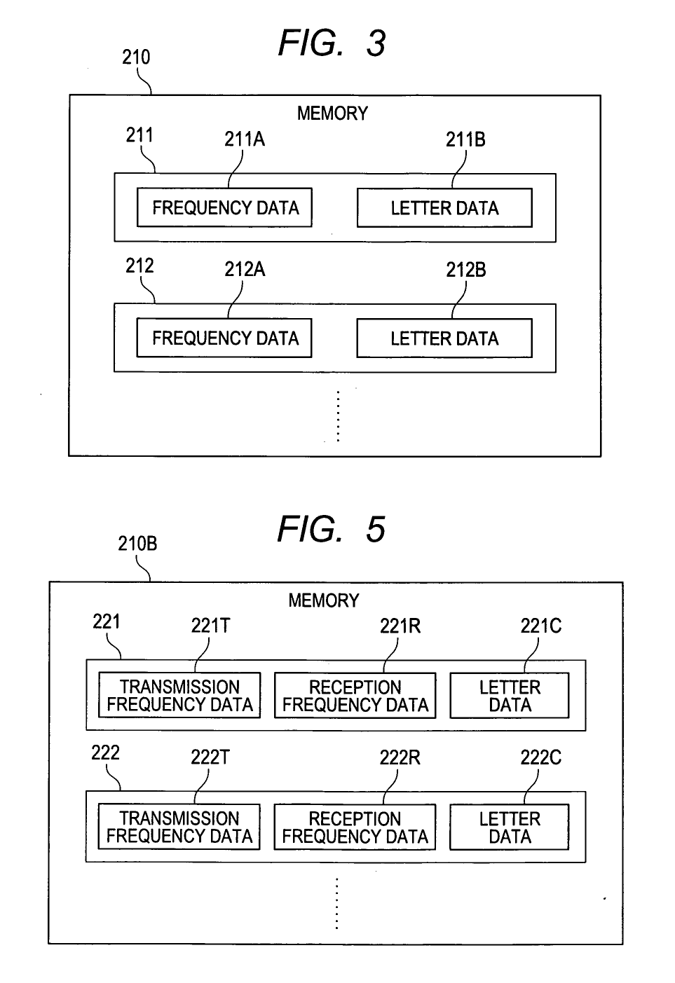

With reference to FIG. 3, the memory 210 stores data sets 211, 212, . . . about respective memory channels. The memory 210 may store only one data set about a memory channel. Each of the data sets has frequency data and letter or character data. For example, the data set 211 has frequency data 211A and letter or character data 211B, and the data set 212 has frequency data 212A and letter or character data 212B. In each data set, the frequency data represents the frequency assigned to the related memory channel while the letter or character data represents letters or characters of the memory name assigned to the related memory channel.

When being actuated, the VFO/memory change switch 109 outputs a mode change command to the control section 205 (the memory channel controller 205d). In the case where the control section 205 (the memory channel controller 205d) receives a mode change command during the VFO mode of operation of the communication device 100, the control section 205 changes operation of the communication device 100 to the memory channel mode. In the case where the control section 205 receives a mode change command during the memory channel mode of operation of the communication device 100, the control section 205 changes operation of the communication device 100 to the VFO mode.

Immediately before operation of the communication device 100 is changed from the VFO mode to the memory channel mode, the control section 205 responds to the mode change command and thereby stores, into the rewritable nonvolatile memory or the RAM, frequency data representing the current frequency used by the radio section 201 (that is, the current frequency to which the radio section 201 tunes). The frequency represented by the stored frequency data is labeled as the last frequency used in the VFO mode of operation before operation of the communication device 100 is changed to the memory channel mode. In addition, the control section 205 reads out, from the rewritable nonvolatile memory or the RAM, frequency data representing the frequency assigned to the memory channel used last, and changes or sets the frequency used by the radio section 201 (that is, the frequency to which the radio section 201 tunes) to the frequency assigned to the memory channel used last.

Immediately before operation of the communication device 100 is changed from the memory channel mode to the VFO mode, the control section 205 responds to the mode change command and thereby stores, into the rewritable nonvolatile memory or the RAM, frequency data representing the frequency assigned to the currently-used memory channel. The frequency represented by the stored frequency data is labeled as the frequency assigned to the memory channel used last. In addition, the control section 205 reads out, from the rewritable nonvolatile memory or the RAM, frequency data representing the last frequency used in the preceding VFO mode of operation, and changes or sets the frequency used by the radio section 201 (that is, the frequency to which the radio section 201 tunes) to the last frequency used in the preceding VFO mode of operation.

In the case where the frequency currently used by the radio section 205 is indicated by the display 107 during the VFO mode of operation of the communication device 100, when the monitor switch 106 is pushed, the muting of the audio output is canceled while the indicated frequency remains unchanged. Similarly, in the case where the frequency assigned to the currently-used memory channel is indicated by the display 107 during the memory channel mode of operation of the communication device 100, when the monitor switch 106 is pushed, the muting of the audio output is canceled and the indicated frequency remains unchanged.

In the case where the memory name assigned to the currently-used memory channel is indicated by the display 107 during the memory channel mode of operation of the communication device 100, when the monitor switch 106 is pushed, the muting of the audio output is canceled and the frequency assigned to the currently-used memory channel is indicated by the display 107. Indication of the frequency replaces indication of the memory name on the display 107. Alternatively, indication of the frequency may be added to indication of the memory name. The cancel of the muting allows the user to check whether a received signal is present in or absent from the frequency monitored by the radio section 201. The frequency indication allows the user to confirm the frequency assigned to the currently-used memory channel. When the monitor switch 106 is released, the audio output is muted again and the memory name assigned to the currently-used memory channel is indicated by the display 107 again.

In the case where the monitor switch 106 is pushed to cancel the muting of the audio output and the frequency assigned to the currently-used memory channel is indicated by the display 107 during the memory channel mode of operation of the communication device 100, when the rotary encoder 102 is actuated, the control section 205 (the frequency controller 205c) enables the VFO so that the frequency to which the radio section 201 tunes is changed successively from one to the next among frequencies spaced at predetermined intervals and starting from the present memory channel frequency in accordance with rotation of the rotary shaft of the rotary encoder 102. When the monitor switch 106 is released thereafter, the control section 205 controls the mute section 202 to mute the audio output again and controls the display 107 to indicate the memory name assigned to the currently-used memory channel again. In addition, the control section 205 accesses the memory 210 and writes frequency data, which represents the last VFO-based frequency to which the radio section 201 tunes, over the frequency data in the stored data set about the currently-used memory channel. Writing the frequency data representative of the last VFO-based frequency over the frequency data in the data set is performed regardless of whether a received signal is present or absent.

Thus, during the memory channel mode of operation of the communication device 100, pushing the monitor switch 106 allows the user to confirm the frequency assigned to the currently-used memory channel and check whether or not the frequency assigned to the currently-used memory channel is occupied by an another station. Furthermore, actuation of the monitor switch 106 and the rotary encoder 102 allows the user to easily change or update the frequency assigned to the currently-used memory channel.

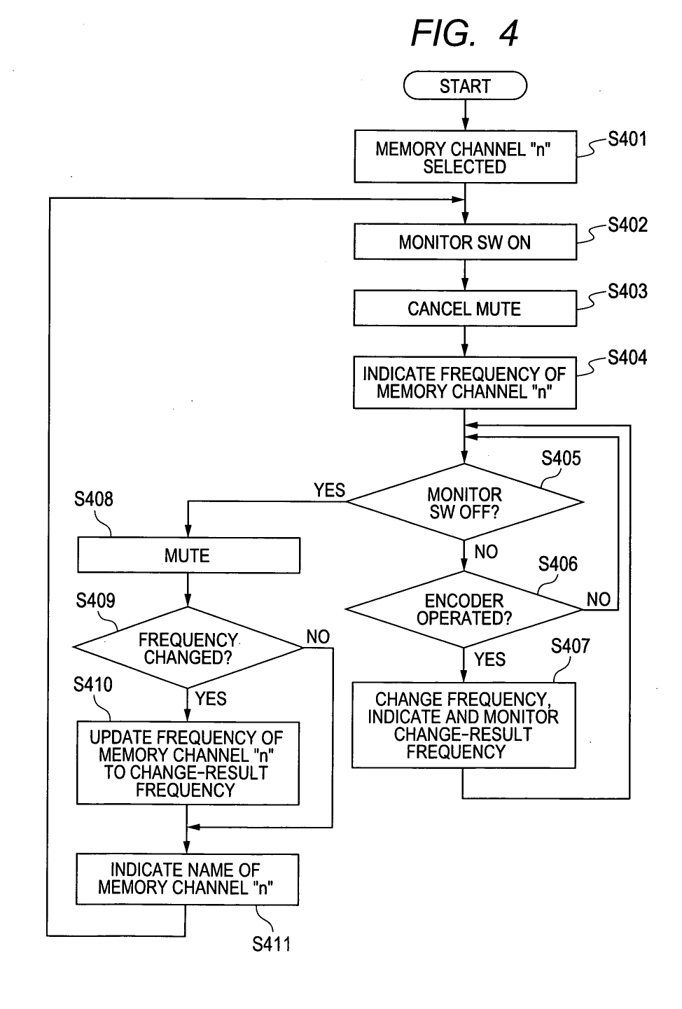

The control section 205 may operate in accordance with the control program stored in the internal ROM or RAM. FIG. 4 is a flowchart of a segment (a subroutine) of the control program which is executed during the memory channel mode of operation of the communication device 100.

With reference to FIG. 4, a first step S401 of the program segment identifies a currently-used memory channel “n”, that is, a memory channel “n” currently selected among all the memory channels. It should be noted that one can be selected from the memory channels as a currently-used memory channel “n” by actuating the rotary encoder 102 when the monitor switch 106 is in its OFF position during the memory channel mode of operation of the communication device 100. After the step S401, the program advances to a step S402.

The step S402 checks a signal from the monitor switch 106 and thereby decides whether or not the monitor switch 106 is in its ON position (that is, whether or not the monitor switch 106 is pushed). When the monitor switch 106 is in its ON position, the program advances from the step S402 to a step S403. Otherwise, the step S402 is repeated.

The step S403 controls the mute section 202 to cancel the muting of the audio output of the communication device 100.

A step S404 following the step S403 controls the display 107 to replace indication of the memory name assigned to the currently-used memory channel “n” by indication of the frequency assigned to the currently-used memory channel “n”. The step S404 may control the display 107 to add indication of the frequency to indication of the memory name. After the step S404, the program advances to a step S405.

It should be noted that the steps S403 and S404 may be exchanged in sequence position.

The above frequency indication allows the user to confirm the frequency assigned to the currently-used memory channel “n”. The above cancel of the muting allows the user to monitor the frequency assigned to the currently-used memory channel “n” and check whether or not the monitored frequency is occupied by another station.

The step S405 checks a signal from the monitor switch 106 and thereby decides whether or not the monitor switch 106 is in its OFF position (that is, whether or not the monitor switch 106 is released). When the monitor switch 106 is in its OFF position, the program advances from the step S405 to a step S408. Otherwise, the program advances from the step S405 to a step S406.

In the case where the monitor switch 106 remains in its ON position, the frequency to which the radio section 201 tunes can be changed on a VFO basis from the frequency assigned to the currently-used memory channel “n” as the rotary encoder 102 is actuated.

The step S406 checks a signal from the rotary encoder 102 and thereby decides whether or not the rotary encoder 102 is actuated. When the rotary encoder 102 is actuated, the program advances from the step S406 to a step S407. Otherwise, the program returns from the step S406 to the step S405.

The step S407 checks the signal from the rotary encoder 102 and controls the radio section 201 on a VFO basis to change the frequency to which the radio section 201 tunes by a predetermined increment or a predetermined decrement depending on the direction of the actuation of the rotary encoder 102. Thus, the change-result frequency is monitored by the radio section 201. The step S407 controls the display 107 to indicate the change-result frequency instead of the indicated before-change frequency. After the step S407, the program returns to the step S405. Reiteration of the step S407 causes the process that the frequency to which the radio section 201 tunes is changed successively from one to the next among frequencies spaced at predetermined intervals and starting from the present memory channel frequency as the rotary encoder 102 is actuated.

The step S408 controls the mute section 202 to mute the audio output of the communication device 100.

A step S409 following the step S408 decides whether or not the frequency to which the radio section 201 tunes has been changed by the step S407. When the frequency to which the radio section 201 tunes has been changed, the program advances from the step S409 to a step S410. Otherwise, the program jumps from the step S409 to a step S411.

The step S410 accesses the memory 210 and writes frequency data representative of the last change-result frequency over the frequency data in the stored data set about the currently-used memory channel “n”. Thus, the step S410 stores the frequency data representative of the last change-result frequency into the memory 210 for the currently-used memory channel “n”. In this way, the original frequency assigned to the currently-used memory channel “n” is updated to the last change-result frequency when the frequency to which the radio section 201 tunes has been changed by the step S407. After the step S410, the program advances to the step S411.

The step S411 controls the display 107 to indicate the memory name assigned to the currently-selected memory channel “n”. After the step S411, the program returns to the step S402.

The step S409 may be omitted. In this case, regardless of whether or not the rotary encoder 102 is actuated, the step S410 detects the frequency indicated by the display 107 immediately before the monitor switch 106 is released, and writes frequency data representative of the detected frequency over the frequency data in the stored data set about the currently-used memory channel “n”. Thus, the detected frequency is set as a new frequency assigned to the currently-used memory channel “n”.

Accordingly, a frequency assigned to each memory channel can easily be updated to a desired frequency.

The memory write switch 110 is electrically connected with the control section 205 (the memory channel controller 205d). The memory write switch 110 informs the control section 205 whether or not it is pushed.

When the memory write switch 110 is pushed once, the control section 205 sets the communication device 100 in a memory-write stand-by state and controls the display 107 to indicate the ID number of a currently-selected memory channel. In the case where the communication device 100 is in the memory-write stand-by state, when the rotary encoder 102 is actuated, the control section 205 changes the currently-selected memory channel successively from one to the next of the memory channels in accordance with actuation of the rotary encoder 102. When the currently-selected memory channel comes into agreement with desired one, the memory write switch 110 is pushed again. The control section 205 accesses the memory 210 in response to this push of the memory write switch 110 and thereby writes frequency data representative of the frequency to which the radio section 201 tunes over the frequency data in the stored data set about the currently-selected memory channel (the desired memory channel).

Alternatively, the memory write procedure may be implemented as follows. When the memory write switch 110 is pushed, the control section 205 sets the communication device 100 in the memory-write stand-by state. As long as the memory write switch 110 continues to be pushed, the communication device 100 remains in the memory-write stand-by state. In the case where the communication device 100 is in the memory-write stand-by state, the control section 205 allows selection of one from the memory channels as a directed memory channel in accordance with actuation of the rotary encoder 102. When the memory write switch 110 is released thereafter, the control section 205 moves the communication device 100 out of the memory-write stand-by state. At the same time, the control section 205 accesses the memory 210 and thereby writes frequency data representative of the frequency to which the radio section 201 tunes over the frequency data in the stored data set about the currently-selected memory channel (the desired memory channel).

The control section 205 is designed so that after the frequency data has been written in the stored data set about the desired memory channel, a memory name editing function can be selected from various setting functions by actuating the directional pad 111. When the memory name editing function is selected, the control section 205 controls the display 107 to indicate letters or characters and allows desired ones to be selected from the indicated letters or characters by actuating the directional pad 111. The selected letters or characters represent a desired memory name to be assigned to the currently-selected memory channel (the desired memory channel). Then, the control section 205 accesses the memory 210 and thereby writes letter or character data representative of the desired memory name over the letter or character data in the stored data set about the currently-selected memory channel (the desired memory channel). Selection of the desired letters or characters may be implemented through an input means other than the directional pad 111.

### Second Embodiment

A second embodiment of this invention is similar to the first embodiment thereof except for design changes explained below.

In the second embodiment of this invention, the steps S409 and S410 are omitted so that the step S408 is directly followed by the step S411. Therefore, regarding the memory 210, the frequency data in the stored data set about the currently-used memory channel “n” is prevented from being updated to the frequency data representative of the change-result frequency. Accordingly, the original frequency data in the stored data set about the currently-used memory channel “n” is protected. The control section 205 discards the frequency data representative of the change-result frequency when use thereof ends.

### Third Embodiment

A third embodiment of this invention is similar to the first embodiment thereof except for design changes explained below.

In the third embodiment of this invention, the memory channels are separated into a first group and a second group. For each memory channel in the first group, the steps S409 and S410 are present so that as in the first embodiment of this invention, the frequency data in the intra-memory data set about the memory channel is updated to the frequency data representative of the change-result frequency when the frequency to which the radio section 201 tunes has been changed by the step S407.

For each memory channel in the second group, the steps S409 and S410 are omitted so that the step S408 is directly followed by the step S411. Therefore, regarding the memory 210, the frequency data in the stored data set about the memory channel is prevented from being updated to the frequency data representative of the change-result frequency as in the second embodiment of this invention. The control section 205 discards the frequency data representative of the change-result frequency when use thereof ends.

### Fourth Embodiment

A fourth embodiment of this invention is similar to one of the first to third embodiments thereof except for design changes explained below.

In radio communications, a typical repeater uses different frequencies for signal transmission and signal reception respectively. The communication device 100 in the fourth embodiment of this invention can communicate with another communication device via such a repeater. Accordingly, a signal-transmission frequency and a signal-reception frequency which differ from each other can be set in the communication device 100. Thus, the communication device 100 can operate in a split mode where the frequency used for signal transmission and the frequency used for signal reception differ from each other. The communication device 100 can directly communicate with another communication device on a dual-frequency or split-frequency communication basis such that the frequency used for signal transmission by the device 100 is equal to the frequency used for signal reception by the other device while the frequency used for signal reception by the device 100 is equal to the frequency used for signal transmission by the other device.

The communication device 100 in the fourth embodiment of this invention includes a memory 210B of FIG. 5 instead of the memory 210 (see FIGS. 2 and 3). The memory 210B stores data sets 221, 222, . . . about respective memory channels. For the split mode of operation, each of the data sets has transmission frequency data, reception frequency data, and letter or character data. For example, the data set 221 has transmission frequency data 221T, reception frequency data 221R, and letter or character data 221C, and the data set 222 has transmission frequency data 222T, reception frequency data 222R, and letter or character data 222C. In each data set, the transmission frequency data represents the frequency used for signal transmission and assigned to the related memory channel and the reception frequency data represents the frequency used for signal reception and assigned to the related memory channel while the letter or character data represents letters or characters of the memory name assigned to the related memory channel. In each data set, the frequency represented by the transmission frequency data and the frequency represented by the reception frequency data are different from or equal to each other.

To implement the split mode and the memory channel mode of operation of the communication device 100, the control section 205 reads out the transmission frequency data, the reception frequency data, and the letter or character data about the currently-used memory channel. The control section 205 controls the radio section 201 in response to the transmission frequency data and the reception frequency data so that the radio section 201 tunes to the frequency represented by the reception frequency data when the communication device 100 is in its reception state, and that the radio section 201 tunes to the frequency represented by the transmission frequency data when the communication device 100 is in its transmission state.

The communication device 100 has a function (reverse function) of exchanging the frequency used for signal transmission and the frequency used for signal reception during the split mode of operation.

The body of the communication device 100 may be provided with a reverse switch at a position where user's hand pushing the monitor switch 106 does not interfere with an access to the reverse switch. The control section 205 is electrically connected with the reverse switch. The control section 205 controls the radio section 201 in response to actuation of the reverse switch to implement the reverse function.

The control section 205 may regard one of the power supply switch 108, the VFO/memory change switch 109, the memory write switch 110, and the directional pad or cross key 111 as such a reverse switch provided that the monitor switch 106 is pushed.

In the case where the communication device 100 operates in the split mode and the memory channel mode, when the monitor switch 106 is pushed, the muting of the audio output is canceled so that the user can monitor the frequency used for signal reception. In this case, when the reverse switch is actuated also, the control section 205 controls the radio section 201 and thereby exchanges the frequency used for signal transmission and the frequency used for signal reception so that the user can monitor the frequency used for signal transmission instead of the frequency used for signal reception.

In the case where the monitor switch 106 is pushed during the memory channel mode of operation of the communication device 100, the frequency used for signal transmission or the frequency used for signal reception is changed in accordance with actuation of the rotary encoder 102 as in one of the first to third embodiments of this invention. The frequency used for signal reception can be changed while being indicated by the display 107 and being monitored by the user. By implementing the reverse function, the frequency used for signal transmission can be changed while being indicated by the display 107 and being monitored by the user.

As in the first embodiment of this invention, the control section 205 writes frequency data representative of the last change-result frequency for signal reception over the reception frequency data in the stored data set about the currently-used memory channel. The control section 205 writes frequency data representative of the last change-result frequency for signal transmission over the transmission frequency data in the stored data set about the currently-used memory channel. As in the second embodiment of this invention, the control section 205 may discard the frequency data representative of the last change-result frequency for signal reception and the frequency data representative of the last change-result frequency for signal transmission when use thereof ends.

In the case where the monitor switch 106 is pushed during the memory channel mode of operation of the communication device 100, the control section 205 may operate to simultaneously change the frequency used for signal transmission and the frequency used for signal reception in accordance with actuation of the rotary encoder 102 in a manner such that an offset frequency interval equal to the difference between the frequency used for signal transmission and the frequency used for signal reception remains constant.

### Fifth Embodiment

A fifth embodiment of this invention is similar to one of the first to fourth embodiments thereof except for design changes explained below.

In the fifth embodiment of this invention, the radio section 201 recovers a word of a prescribed digital code from a received signal. The radio section 201 notifies the recovered digital code word to the control section 205.

The memory 210 (or 210B) or one of the memories within the control section 205 stores an assigned word of the prescribed digital code. The control section 205 reads out the assigned digital code word from the memory. The control section 205 collates the recovered digital code word with the assigned digital code word. When the result of the collation indicates that the recovered digital code word matches the assigned digital code word, the control section 205 controls the mute section 202 to unmute the audio output. Otherwise, the control section 205 controls the mute section 202 to mute the audio output.

The radio section 201 may recover an address of a destination from a received signal. The radio section 201 notifies the recovered address to the control section 205. The memory 210 (or 210B) or one of the memories within the control section 205 stores an address assigned to the communication device 100. The control section 205 reads out the assigned address from the memory. The control section 205 collates the recovered address with the assigned address to decide whether or not the received signal is directed to the communication device 100. When the result of the collation indicates that the received signal is directed to the communication device 100, the control section 205 controls the mute section 202 to unmute the audio output. Otherwise, the control section 205 controls the mute section 202 to mute the audio output.

### Sixth Embodiment

A sixth embodiment of this invention is similar to one of the first to fifth embodiments thereof except for design changes explained below.

The control section 205 in the sixth embodiment of this invention is designed so that during the push of the monitor switch 106, the frequency (the signal transmission frequency or the signal reception frequency) assigned to the currently-used memory channel is changed or updated in accordance with actuation of the rotary encoder 102 while being indicated by the display 107.

### Seventh Embodiment

A seventh embodiment of this invention is similar to one of the first to sixth embodiments thereof except for design changes explained below.

The communication device 100 in the seventh embodiment of this invention has a terminal electrically connectable with an external computer system such as a personal computer. When the terminal is electrically connected with the external computer system, the control section 205 is electrically coupled with the external computer system through the terminal. In this case, the external computer system can access the memory 210 (or 210B) through the control section 205. Thus, by operating the external computer system, frequency data and letter or character data in a stored data set about each memory channel in the memory 210 (or 210B) can be updated so that the frequency and the memory name assigned to the memory channel can be changed. Furthermore, by operating the external computer system, a new data set about a memory channel can be written into the memory 210 (or 210B).

What is claimed is:

1. A portable radio communication device comprising:
a radio section including a transmitting section and a receiving section, the transmitting section being configured to subject a to-be-transmitted signal to modulation to get a modulation-result signal and transmit the modulation-result signal, the receiving section being configured to receive an incoming signal and subject the received incoming signal to demodulation to get a demodulation-result signal;
a frequency operation section configured to vary at least one of a frequency used by the radio section for signal transmission and a frequency used by the radio section for signal reception when being operated;
a mute section configured to mute the outputting of the demodulation-result signal;
a mute cancel operation section configured to cancel the muting by the mute section when being operated;
a memory configured to store data sets assigned to respective memory channels, wherein each of the data sets includes frequency data representing at least one of a frequency used for signal transmission and a frequency used for signal reception, and letter data representing letters;
a display; and
a display control section configured to access the memory and control the display to indicate letters represented by letter data in a data set assigned to selected one of the memory channels when the mute cancel operation section is not operated to cancel the muting, and configured to access the memory and control the display to indicate at least one of a frequency for signal transmission and a frequency for signal reception which are represented by frequency data in the data set assigned to the selected one of the memory channels when the mute cancel operation section is operated to cancel the muting.

2. A portable radio communication device as recited in claim 1, further comprising a general operation section configured to implement various types of setting in the communication device, wherein the mute cancel operation section and the general operation section are designed so that when the mute cancel operation section is operated by user's one hand, the general operation section can be operated by user's other hand without interference with user's one hand.

3. A portable radio communication device as recited in claim 2, further comprising a mute control section configured to decide whether a received signal is present or absent, and enable the mute section when it is decided that a received signal is absent.

4. A portable radio communication device as recited in claim 2, further comprising a mute control section configured to decide whether a specified signal addressed to the communication device is present in or absent from a received signal, and enable the mute section when it is decided that a specified signal addressed to the communication device is absent from a received signal.

5. A portable radio communication device as recited in claim 3, wherein a frequency used by the radio section is varied as the frequency operation section is operated in cases where the display indicates a frequency in response to operation of the mute cancel operation section.

6. A portable radio communication device as recited in claim 5, wherein frequency data representing a varied frequency used by the radio section at a moment of the end of operation of the mute cancel operation section is written over the frequency data in the data set assigned to the selected one of the memory channels.

7. A portable radio communication device as recited in claim 5, wherein frequency data representing a varied frequency used by the radio section at a moment of the end of operation of the mute cancel operation section is discarded.

8. A portable radio communication device as recited in claim 5, wherein the memory channels are separated into a first group and a second group, wherein frequency data representing a varied frequency used by the radio section at a moment of the end of operation of the mute cancel operation section is written over the frequency data in the data set assigned to the selected one of the memory channels in cases where the selected one of the memory channels is in the first group, and wherein frequency data representing a varied frequency used by the radio section at a moment of the end of operation of the mute cancel operation section is discarded in cases where the selected one of the memory channels is in the second group.

9. A portable radio communication device as recited in claim 5, further comprising reception frequency changing means configured to exchange a frequency used by the radio section for signal transmission and a frequency used by the radio section for signal reception to monitor the frequency for signal transmission when being operated, wherein the frequency for signal transmission and the frequency for signal reception are alternately indicated each time the reception frequency changing means is operated while the mute cancel operation section remains operated.

10. A portable radio communication device as recited in claim 9, wherein a frequency used by the radio section for signal reception is varied as the frequency operation section is operated in cases where the display indicates a frequency for signal reception in response to operation of the mute cancel operation section.

11. A portable radio communication device as recited in claim 9, wherein a frequency used by the radio section for signal transmission is varied as the frequency operation section is operated in cases where the display indicates a frequency for signal transmission in response to operation of the mute cancel operation section and operation of the reception frequency changing means.

12. A portable radio communication device as recited in claim 9, wherein a frequency used by the radio section for signal transmission and a frequency used by the radio section for signal reception are simultaneously varied and a difference therebetween remains constant as the frequency operation section is operated in cases where the display indicates a frequency in response to operation of the mute cancel operation section.

13. A portable radio communication device comprising:
a radio section using a frequency for at least one of signal reception and signal transmission;
means for setting the frequency used by the radio section to a frequency assigned to a memory channel;
an audio output circuit;
a switch;
a mute circuit muting the audio output circuit when the switch is not operated, and unmuting the audio output circuit when the switch is operated;
means for indicating to a user a name assigned to the memory channel when the switch is not operated; and
means for indicating to the user the frequency assigned to the memory channel when the switch is operated.

14. A portable radio communication device as recited in claim 13, wherein indication of the frequency replaces indication of the name when the switch is operated.

15. A portable radio communication device as recited in claim 13, wherein indication of the frequency is added to indication of the name when the switch is operated.
